(19) United States
(12) Patent Application Publication
(10) Pub. No.: US 2020/0167780 A1
(43) Pub. Date: May 28, 2020

(54) SYSTEM AND METHOD FOR LINKING AUTHENTICATION AND AUTHORIZATION PROCESSES IN PAYMENT CARD-BASED FINANCIAL TRANSACTIONS

(71) Applicant: Mastercard International Incorporated, Purchase, NY (US)

(72) Inventor: Sheryl J. Lock, St. Charles, MO (US)

(73) Assignee: Mastercard International Incorporated, Purchase, NY (US)

(21) Appl. No.: 16/202,202

(22) Filed: Nov. 28, 2018

(51) Int. Cl. G06Q 20/40

(52) U.S. Cl. CPC G06Q 20/409; G06Q 20/4016

(57) ABSTRACT

A system and method for linking in real-time otherwise independent authentication and authorization processes in payment card-based financial transactions. An interchange network receives an authentication approval message via an authentication network from an authentication service provider, with the authentication approval message including first information, such as an electronic token. The interchange network generates and sends an advice message, which includes the first information, to a card-issuer of the payment card communicating that the authentication approval message was received. Subsequently, the card-issuer receives an authorization request message via an authorization network from a transaction source, with the authorization request message including second information which should be identical to the first information. The card-issuer compares the first information from the advice message to the second information from the authorization request message, and sends an authorization disapproval message to the transaction source if the first information does not match the second information.

### FIELD

The present invention relates to systems and methods for processing financial transactions, and more particularly, embodiments concern a system and method for linking in real-time otherwise independent authentication and authorization processes in payment card-based financial transactions.

### BACKGROUND

Card-based financial transactions involve an initial authentication process to determine whether the purchaser is the card-holder they claim to be, and a subsequent authorization process to determine whether the authenticated card-holder has sufficient funds available to make the purchase. For example, Mastercard currently switches approximately 186 million authentication requests and 100 million fully authenticated authorization requests each month. The initial authentication process helps to increase approval rates and reduce fraud, and is typically performed by a third-party authentication service and occurs independent of the purchase authorization process which is performed by the card-issuer. Because the authentication network does not communicate with the authorization network, it is difficult to link these processes.

In more detail, during the authentication process, a merchant or acquirer communicates with the third-party authentication service's access control server (ACS) which, if authentication is successful, provides an authentication token to the merchant/acquirer. During the authorization process, the merchant/acquirer sends an authorization request including the token via the network's interchange network system. However, the token is merely a value to the card-issuer because the card-issuer was not involved in the authentication process. Thus, the card-issuer accepts the risk of liability for the financial transaction based on authentication data provided by the merchant/acquirer and must trust that it is accurate and genuine. One solution is to enable the interchange network to validate the token for the card-issuer, but this requires that the authentication service or the card-issuer provide the keys for the tokens to the interchange network, which creates security concerns.

This background discussion is intended to provide information related to the present invention which is not necessarily prior art.

### SUMMARY

Embodiments address the above-described and other problems and limitations in the prior art by providing a system and method for linking in real-time otherwise independent authentication and authorization processes in payment card-based financial transactions. Embodiments bridge independent but related systems and processes involved in processing financial transactions, and in doing so, better inform card-issuers, increase trust and approval rates, and reduce fraud.

In a first embodiment, a method is provided for linking an authentication process and an authorization process in a financial transaction involving a payment card. The method may include the following steps, at least some of which may be performed by a computer having an electronic processor. An interchange network may receive an authentication approval message via an authentication network from an authentication service provider, the authentication approval message including a first information. The interchange network may generate and send an advice message to a card-issuer of the payment card communicating that the authentication approval message was received, the advice message including the first information. The card-issuer may receive an authorization request message via an authorization network from a transaction source, the authorization request message including a second information. The card-issuer may compare the first information from the advice message to the second information from the authorization request message, and send an authorization disapproval message to the transaction source if the first information does not match the second information.

In a second embodiment, a method is provided for linking an authentication process and an authorization process in a financial transaction involving a payment card. The method may include the following steps, at least some of which may be performed by a computer having an electronic processor. A card-issuer of the payment card may receive an advice message from an interchange network communicating that an authentication approval message for the financial transaction was received by the interchange network from an authentication service provider, the advice message including a first information that was included in the authentication message. The card-issuer may receive an authorization request message for the financial transaction via an authorization network from a transaction source, the authorization request message including a second information. The card-issuer may compare the first information from the advice message to the second information from the authorization request message, and send an authorization disapproval message to the transaction source if the first information does not match the second information.

In a third embodiment, a system is provided for linking an authentication process and an authorization process in a financial transaction involving a payment card. The system may include an authentication network, an authorization network, an interchange network, and a card-issuer. The authentication network may communicate authentication messages, and the authorization network may communicate authorization messages. The interchange network may receive an authentication approval message via the authentication network from an authentication service provider, the authentication approval message including a first information. The interchange network may generate and send an advice message to the card-issuer communicating that the authentication approval message was received, the advice message including the first information. The card-issuer may receive an authorization request message via the authorization network from a transaction source, the authorization request message including a second information. The card-issuer may compare the first information from the advice message to the second information from the authorization request message, and may send an authorization disapproval message to the transaction source if the first information does not match the second information.

Various implementations of the foregoing embodiments may include any one or more the following additional or alternative features. The first information and the second information may include an electronic token. The first information and the second information may include one or more of a name of the transaction source, a primary account number used at the transaction source, an authentication value indicating an authentication status (successful or otherwise) or an attempted authentication of a cardholder of the payment card, a dollar amount for the financial transaction, a transaction identifier, a type of the authentication, a type of the financial transaction, and/or a date and a time of the authentication request message. The advice message may further include a risk analysis score for the financial transaction.

The system and/or method may further include after the card-issuer receives the authorization request message from the transaction source, the card issuer determining whether the advice message corresponding to the authorization request message was received, and the card-issuer declining the authorization request message if the advice message corresponding to the authorization request message was not received. The system and/or method may further include the interchange network receiving the authorization request message from the transaction source, the interchange network determining whether the authentication approval message corresponding to the authorization request message was generated and sent, and the interchange network declining on behalf of the card-issuer the authorization request message if the authentication approval message corresponding to the authorization request message was not generated and sent.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is a diagram of components in an embodiment of a system for linking an authentication process and an authorization process in a financial transaction involving a payment card;

FIG. 2 is a diagram of components in one implementation of the system of FIG. 1; and

FIG. 3 is a flowchart of steps in an embodiment of a method for linking an authentication process and an authorization process in a financial transaction involving a payment card.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, particular implementations of the present invention can include a variety of combinations and/or integrations of the embodiments described herein.

Broadly, embodiments provide a system and method for linking in real-time otherwise independent authentication and authorization processes in payment card-based financial transactions. Additionally, embodiments may be used by other systems and processes that are disconnected from the authorization process but useful to card-issuers for making decisions about approving authorization requests. Thus, embodiments advantageously bridge independent but related systems and processes involved in processing financial transactions, and in doing so, better inform card-issuers, increase trust and approval rates, and reduce fraud.

In more detail, a cardholder desiring to use a payment card to pay a 3DS-enabled merchant must successfully negotiate both an initial authentication process and a subsequent authorization process to complete the financial transaction. The authentication process may occur on an interchange network's authentication network between the authentication service's ACS, located on a third-party hosted service, and the cardholder. The authentication request and approval occur prior to the purchase authorization request, which is sent to the card-issuer from the merchant/acquirer through the interchange network's authorization network. Because these platforms are not connected, the card-issuer is unaware that the cardholder has been authenticated until the card-issuer receives the request for authorization. The card-issuer must then trust that the merchant/acquirer is passing the correct information. As part of the 3DS protocol, the interchange network operates a directory server (DS) component and receives notification of authentication results as soon as they occur and are passed via results request messages.

In an embodiment of the present technology, the interchange network may link the authentication and authorization processes by creating and sending to the card-issuer an advice message confirming that the initial authentication process actually occurred and providing one or more data elements (e.g., an electronic token) which can be matched by the card-issuer to a subsequently received authorization request. In one implementation, the functions for linking the authentication and authorization processes may be made available as an application programming interface (API) which pushes notification messages to a portal of the card-issuer.

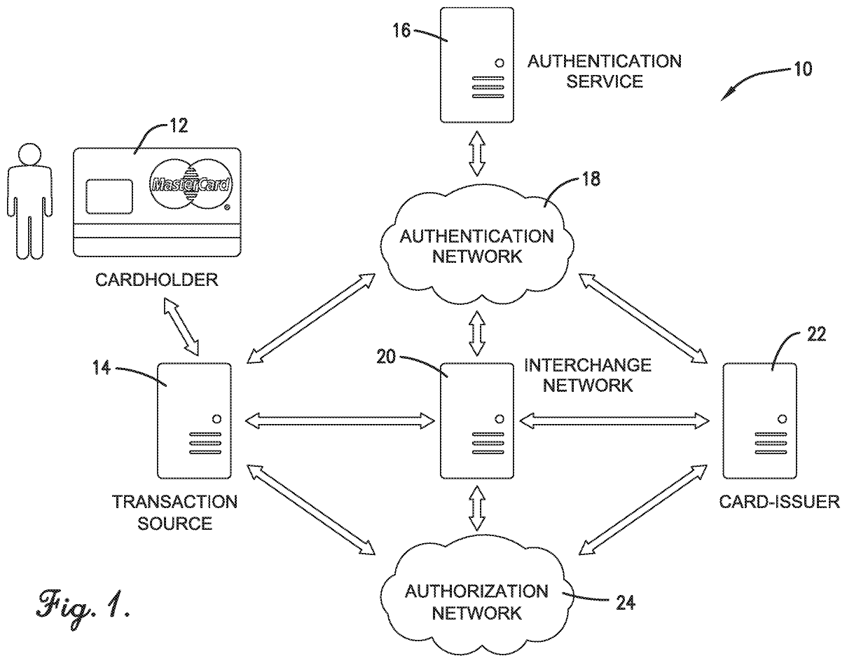

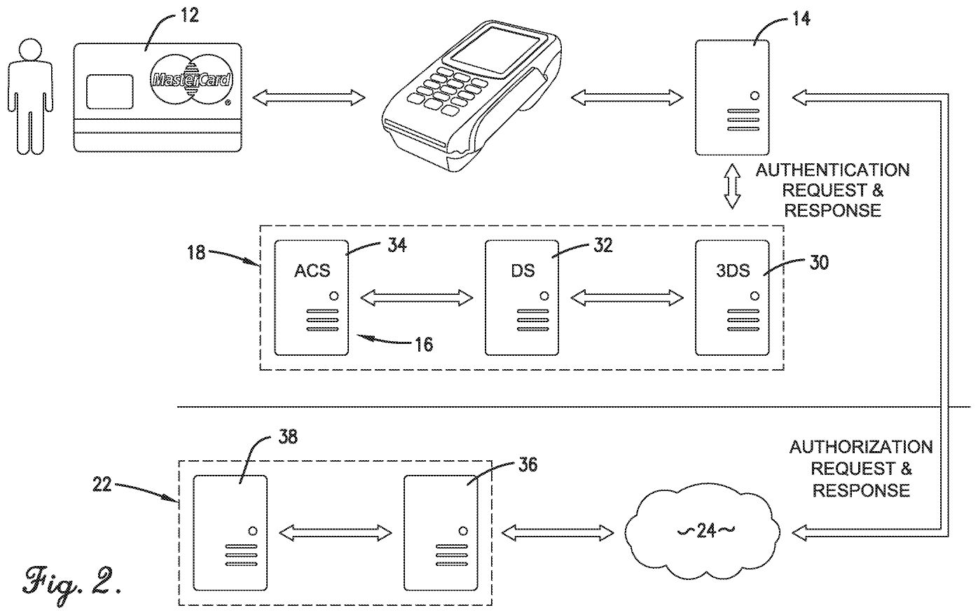

Referring to FIGS. 1 and 2, an embodiment of a system 10 is shown for linking an authentication process and an authorization process in a financial transaction involving a payment card. Broadly, the system 10 and its exemplary operating environment may include a Cardholder 12 of a payment card; a Transaction Source 14; an Authentication Service 16; an Authentication Network 18; an Interchange Network 20; a Card-Issuer 22 of the payment card; and an Authorization Network 24. The Transaction Source 14 may be a merchant, acquirer, or other initiating source of the payment card-based financial transaction. The Authentication Service 16 may be any third-party service provider configured to receive authentication requests from the Transaction Source 14, determine whether authentication should be approved or disapproved, and generate and send a corresponding authentication approval/disapproval message back to the Transaction Source 14. The Authentication Network 18 may be configured to communicate authentication messages, such as requests, approvals, and disapprovals, between the Transaction Source 14 and the Authentication Service 16. In one implementation, shown in FIG. 2, the authentication network 18 may broadly include a 3DS server 30, an interchange network DS 32, and an authentication service ACS server 34.

The Interchange Network 20 may be substantially any interchange network, such as Mastercard, configured to switch and otherwise facilitate payment card-based financial transactions between merchants/acquirers and card-issuers. The Card-Issuer 22 of the payment card may be substantially any bank or other organization configured to issue payment cards. In one implementation, shown in FIG. 2, the card-issuer may include a card-issuer interface processor (IP) 36 and a card-issuer host 38. The Authorization Network 24 may be configured to communicate authorization messages, such as requests, approvals, and disapprovals, between the Card-Issuer 22 and the Transaction Source 14.

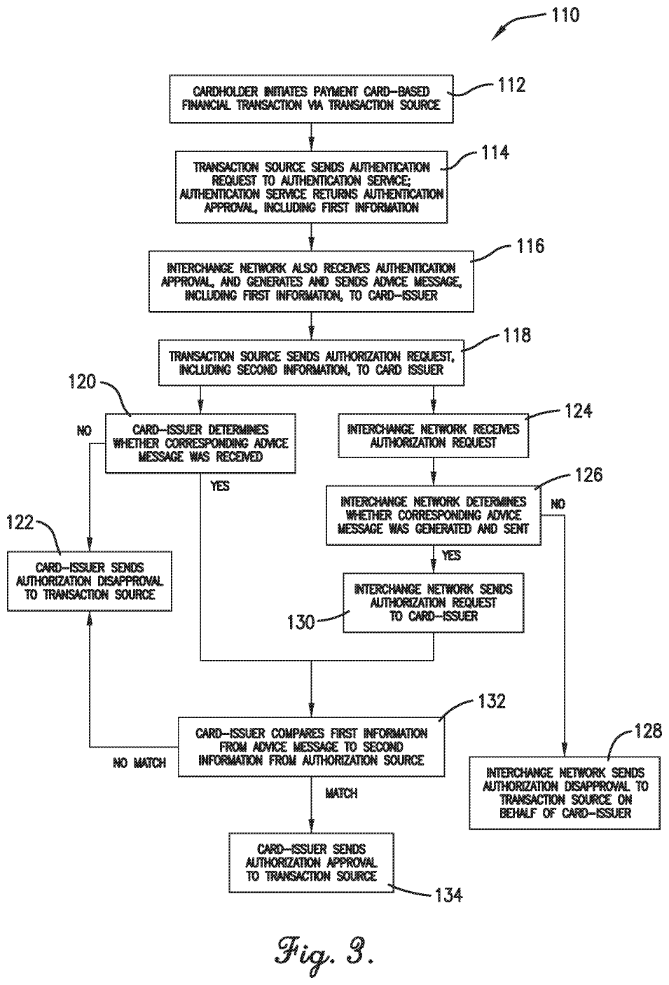

Referring also to FIG. 3, in operation the system 10 may broadly function substantially as follows. The Transaction Source 14 may send an authentication request message to the Authentication Service 16 via the Authentication Network 18, and the Authentication Service 16 may return an authentication approval message, including a first information, which may include an electronic token, to the Transaction Source 14 via the Authentication Network 18, as shown in 114.

The Interchange Network 20 may also receive the authentication approval message, including the first information, via the Authentication Network 18 from the Authentication Service Provider 16, and may generate and send an advice message, including the first information, to the Card-Issuer 22 communicating that the authentication approval message was received, as shown in 116.

In one implementation, when a results request message is received at the Interchange Network 20, the results request information may be passed to an application that generates and sends the advice message to the Card-Issuer 22 confirming and providing details of the authentication. The 3DS 2.X protocol from EMVCo allows the Interchange Network's DS 32 to be part of the final message flow, thereby creating the opportunity to provide this additional value-added service. Thus, the Card-Issuer 22 (or a Stand-In service) receives information about the authentication process and/or other relevant applications from a trusted source prior to the Card-Issuer 22 receiving the corresponding authorization request.

Subsequently, the Card-Issuer 22 may receive an authorization request message via the Authorization Network 24 from the Transaction Source 14, with the authorization request message including a second information which should but may not be identical to the first information, as shown in 118. The Card-Issuer 22 may compare the first information from the advice message to the second information from the authorization request message, as shown in 132, and send an authorization disapproval message to the Transaction Source 14 if the first information does not match the second information, as shown in 122.

The system 10 may include more, fewer, or alternative components and/or perform more, fewer, or alternative actions, including those discussed elsewhere herein, and particularly those discussed in the following section describing the method.

Referring again to FIG. 3, an embodiment of a method 110 is shown for linking an authentication process and an authorization process in a financial transaction involving a payment card. The method 110 may be a corollary to the functionality of the above-described system 10, and may be similarly implemented using the various components of the above-described system 10 and its exemplary operating environment. Broadly, the method 110 may include the following steps, at least some of which may be performed by a computer having an electronic processor.

A payment card-based financial transaction may be initiated by a Cardholder 12 via a Transaction Source 14, as shown in 112. The Transaction Source 14 may be a merchant, acquirer, or other initiating source of the payment card-based financial transaction. The Transaction Source 14 may send an authentication request message to an Authentication Service 16 via an Authentication Network 18, and the Authentication Service 16 may return an authentication approval (or disapproval) message, including first information (e.g., a first electronic token) to the Transaction Source 14 via the authentication network 18, as shown in 114. The Authentication Service 16 may be any third-party service provider configured to receive authentication requests from the Transaction Source 14, determine whether authentication should be approved or disapproved, and generate and send a corresponding authentication approval/disapproval message back to the Transaction Source 14. The Authentication Network 18 may be configured to communicate authentication messages, such as requests, approvals, and disapprovals, between the Transaction Source 14 and the Authentication Service 16. The first information may include any one or more of the Transaction Source's name, the Cardholder's primary account number (PAN),an authentication value (such as, for example, Mastercard's Accountholder Authentication Value (AAV) or Visa's Cardholder Authentication Verification Value (CAVV)) indicating an authentication (successful or otherwise) or an attempted authentication, the dollar amount for the financial transaction (if applicable), a transaction identifier, a type of the authentication, a type of the financial transaction, the first electronic token, and/or the date and time of the authentication request.

An Interchange Network 20 may also receive the authentication approval message via the Authentication Network 18 from the Authentication Service 16, and the Interchange Network 20 may generate and send an advice message, including the first information, to a Card-Issuer 22 of the payment card communicating that the authentication approval message was received, as shown in 116. The Interchange Network 20 may be substantially any interchange network, such as Mastercard, configured to switch and otherwise facilitate payment card-based financial transactions between merchants/acquirers and card-issuers. The Card-Issuer 22 may be substantially any bank or other organization configured to issue payment cards. In one implementation, the Card-Issuer 22 may reply to the advice message from the Interchange Network 20 with an advice response stating whether the Cardholder 12 has sufficient funds for the financial transaction, thereby explaining how the Cardholder 12 might be authenticated and yet declined for authorization.

The Transaction Source 14 may send an authorization request message, including second information (e.g., a second electronic token) to the Card-Issuer 22 via the Authorization Network 24, as shown in 118. The second information may include some or all of the same type of information as the first information, and further, the second information should but may not be identical to the first information contained in the authentication approval message. The Authorization Network 24 may be configured to communicate authorization messages, such as requests, approvals, and disapprovals, between the Card-Issuer 22 and the Transaction Source 14. The advice message may additionally include substantially any relevant information which might be useful to the Card-Issuer, such as a risk analysis score for the financial transaction.

Each authorization request message should be associated with a corresponding advice message confirming prior authentication, so if an authorization request message is received without a corresponding advice message then the Card-Issuer 22 may suspect fraud and either request additional data or decline authorization. Thus, in one implementation, the Card-Issuer 22 may receive the authorization request message from the Transaction Source 14, and the Card-Issuer 22 may determine whether an advice message corresponding to the authorization request message was received, as shown in 120, and the Card-Issuer 22 may decline the authorization request if an advice message corresponding to the authorization request message was not received, as shown in 122.

In an alternative implementation, the Interchange Network 20 may receive the authorization request message from the Transaction Source 14, as shown in 124, and the Interchange Network 20 may determine whether an advice message corresponding to the authorization request message was generated and sent to the Card-Issuer 22, as shown in 126, and the Interchange Network 20 may decline on behalf of the Card-Issuer 22 the authorization request message if an advice message corresponding to the authorization request message was not generated and sent to the Card-Issuer 22, as shown in 128, and the Interchange Network 20 may allow the authorization request message to proceed to the Card-Issuer 22 if an advice message corresponding to the authorization request message was generated and sent to the Card-Issuer 22, as shown in 130. Thus, the Interchange Network 20 may be authorized by the Card-Issuer 22 to pre-emptively decline authorization request messages that do not have or do not match corresponding authentication approval messages.

The Card-Issuer 22 may compare the first information (e.g., the electronic token) from the advice message to the second information from the authorization request message, as shown in 132, and the Card-Issuer 22 may return an authorization disapproval message to the Transaction Source 14 via the Authentication Network 18 if the first information (in part or in its entirety) does not match the second information, as shown in 122, and the Card-Issuer 22 may return an authorization approval message to the Transaction Source 14 via the Authentication Network 18 if the first information (in part or in its entirety) does match the second information, as shown in 134. In more detail, if the first and second information do not match (in whole or in part), then the Card-Issuer may 22 request more data or decline the authorization request, and if the first and second information do match (in whole or in part), then the Card-Issuer 22 can more confidently approve the authorization request.

The computer-implemented method 110 may include more, fewer, or alternative actions, including those discussed elsewhere herein.

Any actions, functions, steps, and the like recited herein may be performed in the order shown in the figures and/or described above, or may be performed in a different order. Furthermore, some steps may be performed concurrently as opposed to sequentially. Although the computer-implemented method is described above, for the purpose of illustration, as being executed by an exemplary system and/or exemplary physical elements, it will be understood that the performance of any one or more of such actions may be differently distributed without departing from the spirit of the present invention.

A computer-readable medium comprising a non-transitory medium may include an executable computer program stored thereon and for instructing one or more processing elements to perform some or all of the steps described herein, including some or all of the steps of the computer-implemented method. The computer program stored on the computer-readable medium may instruct the processing element and/or other components of the system to perform additional, fewer, or alternative actions, including those discussed elsewhere herein.

All terms used herein are to be broadly interpreted unless otherwise stated. For example, the term “payment card” and the like may, unless otherwise stated, broadly refer to substantially any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transaction card can be used as a method of payment for performing a transaction.

The terms “processing element,” “processor,” and the like, as used herein, may, unless otherwise stated, broadly refer to any programmable system including systems using central processing units, microprocessors, microcontrollers, reduced instruction set circuits (RISC), application specific integrated circuits (ASIC), logic circuits, and any other circuit or processor capable of executing the functions described herein. The above examples are example only, and are thus not intended to limit in any way the definition and/or meaning of the term “processing element.” In particular, “a processing element” may include one or more processing elements individually or collectively performing the described functions. In addition, the terms “software,” “computer program,” and the like, may, unless otherwise stated, broadly refer to any executable code stored in memory for execution on mobile devices, clusters, personal computers, workstations, clients, servers, and a processor or wherein the memory includes read-only memory (ROM), electronic programmable read-only memory (EPROM), random access memory (RAM), erasable electronic programmable read-only memory (EEPROM), and non-volatile RAM (NVRAM) memory. The above memory types are exemplary only, and are thus not limiting as to the types of memory usable for storage of a computer program.

The terms “computer,” “computing device,” and the like, as used herein, may, unless otherwise stated, broadly refer to substantially any suitable technology for processing information, including executing software, and may not be limited to integrated circuits referred to in the art as a computer, but may broadly refer to a microcontroller, a microcomputer, a programmable logic controller (PLC), an application specific integrated circuit, and other programmable circuits, and these terms are used interchangeably herein.

The term “communications network” and the like, as used herein, may, unless otherwise stated, broadly refer to substantially any suitable technology for facilitating communications (e.g., GSM, CDMA, TDMA, WCDMA, LTE, EDGE, OFDM, GPRS, EV-DO, UWB, WiFi, IEEE 802 including Ethernet, WiMAX, and/or others), including supporting various local area networks (LANs), personal area networks (PAN), or short range communications protocols.

The term “communications element” and the like, as used herein, may, unless otherwise stated, broadly refer to substantially any suitable technology for facilitating communications, and may include one or more transceivers (e.g., WWAN, WLAN, and/or WPAN transceivers) functioning in accordance with IEEE standards, 3GPP standards, or other standards, and configured to receive and transmit signals via a communications network.

The term “memory element,” “data storage device,” and the like, as used herein, may, unless otherwise stated, broadly refer to substantially any suitable technology for storing information, and may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A method for linking an authentication process and an authorization process in a financial transaction involving a payment card, the method comprising:
receiving by an interchange network an authentication approval message via an authentication network from an authentication service provider, the authentication approval message including a first information;
generating and sending by the interchange network an advice message to a card-issuer of the payment card communicating that the authentication approval message was received, the advice message including the first information;
receiving by the card-issuer an authorization request message via an authorization network from a transaction source, the authorization request message including a second information; and
comparing by the card-issuer the first information from the advice message to the second information from the authorization request message, and sending an authorization disapproval message to the transaction source if the first information does not match the second information.

2. The method of claim 1, the first information and the second information including an electronic token.

3. The method of claim 1, the first information and the second information including one or more of
a name of the transaction source;
a primary account number;
an authentication value indicating an authentication status of a cardholder of the payment card;
a dollar amount for the financial transaction;
a transaction identifier;
a type of the authentication;
a type of the financial transaction; and
a date and a time of the authentication request message.

4. The method of claim 1, the advice message further including a risk analysis score for the financial transaction.

5. The method of claim 1, further including
after receiving by the card-issuer the authorization request message from the transaction source, determining by the card-issuer whether the advice message corresponding to the authorization request message was received; and
declining by the card-issuer the authorization request message if the advice message corresponding to the authorization request message was not received.

6. The method of claim 1, further including
receiving by the interchange network the authorization request message from the transaction source;
determining by the interchange network whether the authentication approval message corresponding to the authorization request message was generated and sent; and
declining by the interchange network on behalf of the card-issuer the authorization request message if the authentication approval message corresponding to the authorization request message was not generated and sent.

7. A method for linking an authentication process and an authorization process in a financial transaction involving a payment card, the method comprising:
receiving by a card-issuer of the payment card an advice message from an interchange network communicating that an authentication approval message for the financial transaction was received by the interchange network from an authentication service provider, the advice message including a first information that was included in the authentication message;
receiving by the card-issuer an authorization request message for the financial transaction via an authorization network from a transaction source, the authorization request message including a second information; and
comparing by the card-issuer the first information from the advice message to the second information from the authorization request message, and sending an authorization disapproval message to the transaction source if the first information does not match the second information.

8. The method of claim 7, the first information and the second information including an electronic token.

9. The method of claim 7, the first information and the second information including one or more of
a name of the transaction source;
a primary account number;
an authentication value indicating an authentication status of a cardholder of the payment card;
a dollar amount for the financial transaction;
a transaction identifier;
a type of the authentication;
a type of the financial transaction; and
a date and a time of the authentication request message.

10. The method of claim 7, the advice message further including a risk analysis score for the financial transaction.

11. The method of claim 7, further including
after receiving by the card-issuer the authorization request message from the transaction source, determining by the card-issuer whether the advice message corresponding to the authorization request message was received; and
declining by the card-issuer the authorization request message if the advice message corresponding to the authorization request message was not received.

12. A system for linking an authentication process and an authorization process in a financial transaction involving a payment card, the system comprising:
an authentication network for communicating authentication messages;
an authorization network for communicating authorization messages;
an interchange network receiving an authentication approval message via the authentication network from an authentication service provider, the authentication approval message including a first information,
the interchange network generating and sending an advice message to a card-issuer communicating that the authentication approval message was received, the advice message including the first information; and
a card-issuer receiving an authorization request message via the authorization network from a transaction source, the authorization request message including a second information,
the card-issuer comparing the first information from the advice message to the second information from the authorization request message, and sending an authorization disapproval message to the transaction source if the first information does not match the second information.

13. The system of claim 12, the first information and the second information including an electronic token.

14. The system of claim 12, the first information and the second information including one or more of
a name of the transaction source;
a primary account number of the transaction source;
an authentication value indicating an authentication status of a cardholder of the payment card;
a dollar amount for the financial transaction;
a transaction identifier;
a type of the authentication;
a type of the financial transaction; and
a date and a time of the authentication request message.

15. The system of claim 12, the advice message further including a risk analysis score for the financial transaction.

16. The system of claim 12, further including after the card-issuer receives the authorization request message from the transaction source, the card issuer determining whether the advice message corresponding to the authorization request message was received, and the card-issuer declining the authorization request message if the advice message corresponding to the authorization request message was not received.

17. The system of claim 12, further including the interchange network receiving the authorization request message from the transaction source, the interchange network determining whether the authentication approval message corresponding to the authorization request message was generated and sent, and the interchange network declining on behalf of the card-issuer the authorization request message if the authentication approval message corresponding to the authorization request message was not generated and sent.
